(19) United States
(12) Patent Application Publication
(10) Pub. No.: US 2007/0134000 A1
(43) Pub. Date: Jun. 14, 2007

(54) Polarization division multiplexed optical transmission system

(75) Inventors: Sang Soo Lee, Daejeon-city (KR); Sang-Kyu Lim, Daejeon-city (KR); HyunWoo Cho, Daejeon-city (KR); JeSoo Ko, Daejeon-city (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/634,925

(22) Filed: Dec. 7, 2006

(30) Foreign Application Priority Data
Dec. 8, 2005 (KR) 10-2005-0120102
Apr. 26, 2006 (KR) 10-2006-0037757

(51) Int. Cl. H04B 10/00

(52) U.S. Cl. 398/155

(57) ABSTRACT

Provided is a polarization division multiplexed optical transmission system including a transmitter and a receiver. The transmitter includes a first light source generating an optical signal having a linear polarization state; a second light source generating an optical signal having a horizontal polarization state; a first signal generator receiving a first data stream to modulate the optical signal output from the first light source using an M method; a second signal generator receiving a second data stream to modulate the optical signal output from the second light source using an N method; and a polarization beam combiner (PBC) multiplexing the optical signals that were modulated using the M and N methods while maintaining the linear and horizontal polarization states.

### CROSS-REFERENCE TO RELATED PATENT APPLICATION

This application claims the benefits of Korean Patent Application No. 10-2005-0120102, filed on Dec. 8, 2005, and Korean Patent Application No. 10-2006-0037757, filed on Apr. 26, 2006, in the Korean Intellectual Property Office, the disclosures of which are incorporated herein in their entirety by reference.

### BACKGROUND OF THE INVENTION

1. Field of the Invention

The present invention relates to a polarization division multiplexed optical transmission system, and more particularly, to an optical transmission system for easily providing a dynamic separate of two polarization multiplexed channels in a receiver regardless of whether the orthogonal polarization states of both polarization multiplexed channels vary through an optical link.

2. Description of the Related Art

In general, many efforts have been conducted to improve spectral efficiency of signals in order to reduce cost per bit in optical transmission systems.

A transmission speed per channel of optical transmission systems is generally 40 Gb/s, but studies have also been conducted with results of transmission speeds of the optical transmission systems of 160 Gb/s and 640 Gb/s.

If ultrahigh speed signals are arranged at narrow channel intervals, spectral efficiency, which is defined by a maximum number of bits per unit channel, increases.

However, spectral efficiency is seriously affected by dispersion at a transmission speed of 40 Gb/s or higher, and the ultrahigh speed signals may be distorted due to a nonlinear phenomenon. Thus, the ultrahigh speed signals may not be arranged at the narrow channel intervals.

According to a report, spectral efficiency of a 10 Gb/s non-return-to-zero (NRZ) signal is 0.8 bit/s/Hz, and spectral efficiency of a 40 Gb/s return-to-zero differential quadrature shifting keying (RZ-DQPSK) signal is 1.6 bit/s/Hz.

Polarization division multiplexing is a method of easily increasing such spectral efficiency. In polarization division multiplexing, an optical channel is split into linearly and horizontally polarized channels, the linearly and horizontally polarized channels carrying other information are transmitted and separate in a receiver, and information, in terms of the linearly and horizontally polarized channels, is received so as to doubly increase spectral efficiency.

However, if polarization division multiplexed signals pass through an optical link, the polarization states of the polarization division multiplexed signals defined in a transmitter of the optical link vary. Thus, the polarization division multiplexed channels may not be easily separate in the receiver of the optical link.

To solve this problem, a method of separateting channels of polarization division multiplexed signals has been proposed. In this method, modulation signals having different low frequencies are applied in two polarization states and detected in a receiver so as to control the two polarization states.

A first example of such a method can be found in the paper called, “1-Tb/s Transmission Experiment,” published by A. R. Charplyvy et al. of Lucent Technologies in the 1996 September issue of IEEE Photonics Technology Letters.

In the above paper, 25 optical channels are linearly polarized in vertical and horizontal directions, modulated at a speed of 20 Gb/s, combined by a polarization beam combiner (PBC), and transmitted through an optical fiber. Next, the two linear polarization states are separate using a polarization controller (PC) and a polarization beam splitter (PBS) in a receiver so as to measure the transmission performance.

Different radio frequency (RF) tones are superimposed on two modulators of the transmitter to easily separate orthogonally polarized signals. Also, the polarization states are controlled using the PC of the receiver so that the RF tones corresponding to crosstalk caused by undesired polarization states become zero in order to remove the crosstalk in the receiver.

However, the detailed contents of the RF tones for separateting the polarization division multiplexed channels have not been described.

A second example of the above mentioned method is U.S. Pat. No. 6,634,808, entitled “Method for Transmitting at least One First and One Second Data Signal in Polarization Division Multiplex in Optical Transmission System”, as applied to United States Patent and Trademark Office by Chirstoph Glingener and registered in Oct. 21, 2003. A claimant of the patent is Siemens Aktiengesellschaft, who is a German citizen and whose patent is more detailed than the previous paper.

The second art discloses a dynamic separate apparatus for polarization division multiplexed channels. The dynamic separate apparatus includes a transmitter, which includes first and second signal generating units, first and second modulating units, a polarization multiplexer, a delayer, and a receiver including a PC, a PBC, first and second optical signal detecting members, first and second filter units, and a controlling unit.

In the above patent, the first and second signal generating units of the transmitter apply first and second signals f1 and f2 having two orthogonal polarization states. Next, the first and second signals f1 and f2 are input to the first and second modulating units to additionally modulate data, and the modulated first and second signals f1 and f2 are transmitted through an optical link.

Also, the first and second signals f1 and f2 that passed the PC and the PBC of the receiver are converted into photoelectric signals and then input to the first and second filter units having data of the first and second signals f1 and f2.

In the second art, the PC of the receiver is controlled by the controlling unit to maximize the intensities of the first and second signals f1 and f2 having passed the first and second filter units in order to achieve the dynamic separate of channels.

However, the transmitter must apply and modulate a signal having an additional frequency besides a data signal to the dynamically separate polarization division multiplexed channels in the receiver.

In such a case, the transmitter may have a complicated structure, and a main data signal may be distorted by the signal having the additional frequency. As a result, signal quality may deteriorate.

### SUMMARY OF THE INVENTION

The present invention provides a polarization division multiplexed optical transmission system for easily dynamically separateting two polarization multiplexed channels in a receiver regardless of the orthogonal polarization states of the two polarization multiplexed channels varying through an optical link, so as to improve spectral efficiency.

According to an aspect of the present invention, there is provided a transmitter of a polarization division multiplexed optical transmission system including: a first light source generating an optical signal having a linear polarization state; a second light source generating an optical signal having a horizontal polarization state; a first signal generator receiving a first data stream to modulate the optical signal output from the first light source using an M method; a second signal generator receiving a second data stream to modulate the optical signal output from the second light source using an N method; and a polarization beam combiner (PBC) multiplexing the optical signals that were modulated using the M and N methods while maintaining the linear and horizontal polarization states.

According to another aspect of the present invention, there is provided a receiver of a polarization division multiplexed optical transmission system including: a polarization controller (PC) controlling polarizations of optical signals multiplexed in orthogonal polarization states; a polarization beam splitter (PBS) comprising a predetermined polarization axis to separate the multiplexed optical signals depending on the orthogonal polarization states; first and second photodetectors converting the separate multiplexed optical signals into electric signals; and first and second clock and data recovery units extracting clock component signals and data from the electrical signals output from the first and second photodetectors.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a polarization division multiplexed optical transmission system for dynamically separateting polarization division multiplexed channels according to an embodiment of the present invention; and

FIG. 2 is a graph illustrating spectrums of 40 Gb/s non-return-to-zero (NRZ) and carrier suppressed return-to-zero (CS-RZ) signals having passed a 40 GHz band pass filter in a receiver of the polarization division multiplexed optical transmission system illustrated in FIG. 1.

### DETAILED DESCRIPTION OF THE INVENTION

Hereinafter, an embodiment of the present invention will be described in detail with reference to the attached drawings.

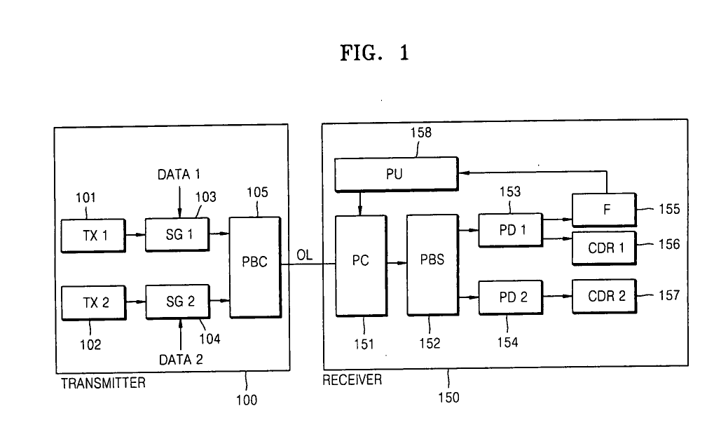

FIG. 1 is a block diagram illustrating a polarization division multiplexed optical transmission system for dynamically separateting polarization division multiplexed channels according to an embodiment of the present invention. Referring to FIG. 1, a transmitter 100 of the polarization division multiplexed optical transmission system includes a first transmission light source (TX1) 101, a second transmission light source (TX2) 102, a first signal generator (SG1) 103, a second signal generator (SG2) 104, and a polarization beam combiner (PBC) 105.

A receiver 150 of the polarization division multiplexed optical transmission system includes a polarization controller (PC) 151, a polarization beam splitter (PBS) 152, a first photodetector (PD1) 153, a second photodetector (PD2) 154, a band pass filter (BPF) 155, a first clock and data recovery unit (CDR1) 156, a second clock and data recovery unit (CDR2) 157, and a signal processing unit (PU) 158.

An optical link (OL) generally formed of an optical fiber or an optical amplifier is positioned between the transmitter 100 and the receiver 150.

The structure and operation of the polarization division multiplexed optical transmission system will now be described.

The first and second transmission light sources 101 and 102 respectively output optical signals that have the same wavelength and are linearly and horizontally polarized to be orthogonal to each other.

The optical signals are respectively modulated by the first and second signal generators 103 and 104.

Data DATA1 and DATA2, which are to be modulated, are directly input to the first and second signal generators 103 and 104, respectively. In the present embodiment, non-return-to-zero (NRZ) and RZ family modulation methods including carrier suppressed return-to-zero (CS-RZ) modulation, return-to-zero differential phase shifting keying (RZ-DPSK) modulation AND RZ modulation and so on, are used.

Non-return-to-zero (NRZ) and Carrier suppressed return-to-zero (CS-RZ) modulation is adopted as an exemplary embodiment of the present embodiment.

The NRZ and CS-RZ modulation methods are used for the following reason. In general, an NRZ signal does not include a clock component, while an RZ-based signal includes a clock component. Thus, the receiver 150 separates two polarization division multiplexed signals using information as to whether a clock component exists.

In the prior art, two modulators are used to adopt the CS-RZ modulation method and have complicated structures. However, a modulator having a simple structure may be used in order to easily adopt the CS-RZ modulation method.

The optical signals modulated using the NRZ and CS-RZ modulation methods remain in the orthogonal polarization states, are combined by the PBC 105, and transmitted through the OL.

The combined signal that passed the OL is separate into two optical signals with polarization states by the PC 151 and the PBS 152. In the present embodiment, a polarization state of an input signal must coincide with a polarization axis of the PBS 152 to optimally separate the input signal into two signals.

In the present embodiment of the present invention, for this purpose, the BPF 155 having a frequency bandpass characteristic corresponding to a transmission speed of the polarization division multiplexed optical transmission system extracts a signal from an output port of the PD1 153. When the power of the extracted signal is a maximum, the PU 158 generates a control signal and applies the control signal to the PC 151 so as to control the polarization states.

In the present embodiment, the control signal is applied to the PC 151 after the intensity of a clock is at a predetermined level or more, so as to prevent a polarization channel from being selected for a weak clock component generated in the NRZ modulation method.

In the present embodiment, signal tracking is performed not only for two polarization channels, but also for a CS-RZ channel due to the following reason.

The orthogonal polarization states of two polarization division multiplexed transmission channels vary through an optical link. In other words, the two polarization division multiplexed signals pass through the same optical line at the same time, and thus the orthogonal polarization states of the two polarization division multiplexed signals may vary. However, the orthogonal polarization states of the two polarization division multiplexed signals may be maintained constant.

Therefore, if the receiver 150 is able to separate only one of the two polarization division multiplexed channels, the other polarization division multiplexed channel may be automatically separate by the PBS 152.

In the present embodiment, the transmission speeds of two polarization division multiplexed channels are the same. However, if the transmission speeds of the two polarization division multiplexed channels are different, a separate channel method of the present invention may be equally adopted.

Also, in the present embodiment, the NRZ and CS-RZ modulation methods are used as modulation methods for the two polarization division multiplexed channels. However, if different modulation methods are used for the two polarization division multiplexed channels, the different modulation methods may be equally adopted.

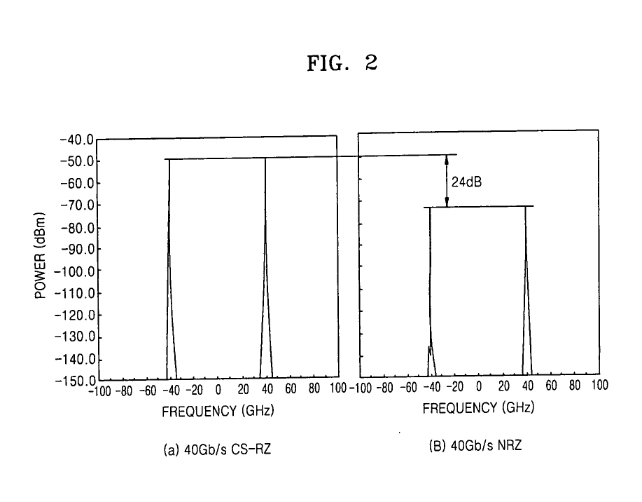

FIG. 2 is a graph illustrating spectrums of 40 Gb/s NRZ and 40 Gb/s CS-RZ signals having passed a 40 GHz the BPF 155 in the receiver 150 of a polarization division multiplexed optical transmission, according to an embodiment of the present invention.

FIG. 2 illustrates spectrums of the 40 Gb/s NRZ and 40 Gb/s CS-RZ signals each having an intermediate frequency of 40 GHz and a bandwidth of 5 GHz, wherein the 40 Gb/s NRZ and CS-RZ signals have passed the BPF 155.

The 40 Gb/s CS-RZ signal has a clock component of 24 dB that is greater than the clock component of the 40 Gb/s NRZ signal in a frequency band of 40 GHz. Thus, both signals may be separate using such a clock component.

Table 1 below shows radio frequency (RF) power of the spectrums detected according to different types of filters in the receiver of the polarization division multiplexed optical transmission system of the present invention.

TABLE 1

| Modulation Method | Filter | RF Power (dBm) |
|---|---|---|
| 40 Gb/s NRZ | Butterworth | −73.4 |
| | Bessel Thomson | −73.4 |
| | Raised Cosine | −73.4 |
| | Chebychev | −76.4 |
| 40 Gb/s CS-RZ | Butterworth | −49.3 |
| | Bessel Thomson | −49.3 |
| | Raised Cosine | −49.3 |
| | Chebychev | −52.3 |

The RF power of the spectrums depends on the type of filter in the receiver of the polarization division multiplexed optical transmission system used to extract a clock component.

Four types of filters such as Butterworth, Bessel Thomson, Raised Cosine, and Chebychev filters were considered.

The intermediate frequencies of the four types of filters were all 40 GHz, transmission bandwidths of the four types of filters were all 5 GHz, and dimensions of the four types of filters were all in the fourth dimension.

The results of a simulation are illustrated in Table 1 above.

When the Butterworth, Bessel Thomson, or Raised Cosine filter is used, the RF power of the 40 Gb/s NRZ signal detected in the frequency band of 40 GHz is −7.34 dBm. When the Chebychev filter is used, the RF power of the 40 Gb/s NRZ signal is −76.4 dBm.

When the Butterworth, Bessel Thomson, or Raised Cosine filter is used, the RF power of the 40 Gb/s CS-RZ signal is −49.3 dBm. When the Chebychev filter is used, the RF power of the 40 Gb/s CS-RZ signal is −52.3 dBm. The difference in power for when the RF power is detected by the Butterworth, Bessel Thomson, or Raised Cosine filter and when the RF power is detected by the Chebychev filter is 3dB. However, the difference in power between the RF power of the 40 Gb/s NRZ signal and the 40 Gb/s CS-RZ signal is 24.1 dB.

Accordingly, the receiver may use the Butterworth, Bessel Thomson, Raised Cosine, or Chebychev filter as a filter used to obtain a control signal for input data.

As described above, according to the present invention, two polarization division multiplexed channels can be modulated using different modulation methods without using pilot tones, and then separate in a receiver. Thus, polarization division multiplexed channels can be easily separate without a signal distortion caused by a method of applying the pilot tones. Also, the receiver and the transmitter of the polarization division multiplexed optical transmission system can have simple structures.

While the present invention has been particularly illustrated and described with reference to exemplary embodiments thereof, it will be understood by those of ordinary skill in the art that various changes in form and details may be made therein without departing from the spirit and scope of the present invention as defined by the following claims.

What is claimed is:

1. A transmitter of a polarization division multiplexed optical transmission system comprising:
a first light source generating an optical signal having a linear polarization state;
a second light source generating an optical signal having a horizontal polarization state;
a first signal generator receiving a first data stream to modulate the optical signal output from the first light source using an M method;
a second signal generator receiving a second data stream to modulate the optical signal output from the second light source using an N method; and
a polarization beam combiner (PBC) multiplexing the optical signals that were modulated using the M and N methods while maintaining the linear and horizontal polarization states.

2. The transmitter of claim 1, wherein the wavelength of the optical signal output from the first light source is equal to the wavelength of the optical signal output from the second light source.

3. The transmitter of claim 1, wherein a transmission speed of the optical signal that was modulated using the M method is same as a transmission speed of the optical signal modulated using the N method.

4. The transmitter of claim 1, wherein the M method is a non-return-to-zero (NRZ) modulation method, and the N method is a return-to-zero (RZ) family modulation method.

5. A receiver of a polarization division multiplexed optical transmission system comprising:
a polarization controller (PC) controlling polarizations of optical signals multiplexed in orthogonal polarization states;
a polarization beam splitter (PBS) comprising a, predetermined polarization axis to separate the multiplexed optical signals depending on the orthogonal polarization states;
first and second photodetectors converting the separate multiplexed optical signals into electric signals; and
first and second clock and data recovery units extracting clock component signals and data from the electrical signals output from the first and second photodetectors.

6. The receiver of claim 5, further comprising:
a bandpass filter filtering a predetermined frequency band of the electrical signal output from the first photodetector; and
a signal processing unit measuring power of the filtered electrical signal and outputting a control signal for re-controlling polarizations of the multiplexed optical signals to detect a polarization state in which the power of the electrical signal is maximum.

7. The receiver of claim 6, wherein the bandpass filter is one of Butterworth, Bessel Thomson, Raised Cosine, and Chebychev filters.

8. The receiver of claim 5, wherein the multiplexed optical signals are optical signals modulated using different modulation methods depending on the orthogonal polarization states.

9. The receiver of claim 8, wherein one of the multiplexed optical signals is modulated using a non-return-to-zero (NRZ) modulation method, and an other one of the multiplexed optical signals is modulated using a return-to-zero (RZ) family modulation method.
